(19) United States
(12) Patent Application Publication
(10) Pub. No.: US 2025/0240066 A1
(43) Pub. Date: Jul. 24, 2025

(54) UPLINK BEAMFORMING

(71) Applicant: QUALCOMM Incorporated, San Diego, CA (US)

(72) Inventors: Subhanshu SAHU, Delhi (IN); Anil Kumar DEVPURA, Hyderabad (IN); Kanchan VERMA, Jaipur (IN); Rahul SHARMA, Chirawa (IN); Sanjeev Yadav YADAV, Ayodhya (IN)

(21) Appl. No.: 18/418,144

(22) Filed: Jan. 19, 2024

(51) Int. Cl. H04B 7/06; H04L 5/00; H04W 72/12; H04W 72/51

(52) U.S. Cl. CPC H04B 7/0617; H04L 5/0051; H04W 72/12; H04W 72/51

(57) ABSTRACT

Apparatus, methods, and computer program products for wireless communication are provided. An example method may include transmitting, to a second network entity, a first indication of a diversity and a second indication of a first quantity of scheduled layers associated with the first network entity. The example method may further include transmitting, to the second network entity, a set of beamforming weights based on the indication of the diversity and the first quantity of scheduled layers.

### TECHNICAL FIELD

The present disclosure relates generally to communication systems, and more particularly, to wireless communication systems with uplink beamforming.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity are provided. The apparatus may include at least one memory and at least one processor coupled to the at least one memory. Based at least in part on information stored in the at least one memory, the at least one processor, individually or in any combination, is configured to transmit to a second network entity, a first indication of a diversity and a second indication of a first quantity of scheduled layers associated with the first network entity. Based at least in part on information stored in the at least one memory, the at least one processor, individually or in any combination, is configured to transmit to the second network entity, a set of beamforming weights based on the indication of the diversity and the first quantity of scheduled layers.

In another aspect of the disclosure, a method, a computer-readable medium, and an apparatus at a first network entity are provided. The apparatus may include at least one memory and at least one processor coupled to the at least one memory. Based at least in part on information stored in the at least one memory, the at least one processor, individually or in any combination, is configured to transmit, to a second network entity, a set of sounding reference signal (SRS) samples. Based at least in part on information stored in the at least one memory, the at least one processor, individually or in any combination, is configured to receive, from the second network entity, a first indication of a diversity and a second indication of a first quantity of scheduled layers associated with the first network entity. Based at least in part on information stored in the at least one memory, the at least one processor, individually or in any combination, is configured to receive, from the second network entity, a set of beamforming weights based on the indication of the diversity and the first quantity of scheduled layers, the set of beamforming weights being based on the set of SRS samples.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4 is a diagram illustrating a network node in communication with a UE via a set of beams, in accordance with various aspects of the present disclosure.

FIG. 5 is a diagram illustrating example communications between a first network entity and a second network entity.

FIG. 6 is a flowchart of a method of wireless communication, in accordance with various aspects of the present disclosure.

FIG. 7 is a flowchart of a method of wireless communication, in accordance with various aspects of the present disclosure.

FIG. 8 is a flowchart of a method of wireless communication, in accordance with various aspects of the present disclosure.

FIG. 9 is a diagram illustrating an example of a hardware implementation for an example network entity, in accordance with various aspects of the present disclosure.

FIG. 10 is a diagram illustrating an example of a hardware implementation for a network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Aspects provided herein may facilitate reducing the size of a C-plane message by introducing new parameters to the C-plane message carrying beam weight(s) and reduce the instances where a beamforming weight of zero would be transmitted. Based on aspects provided herein, a C-plane message carrying beam weight(s) may include a diversity parameter which may inform O-RU regarding whether O-RU diversity variant of uplink beamforming is enabled and a numLayers parameter which may indicate the number of scheduled layers.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

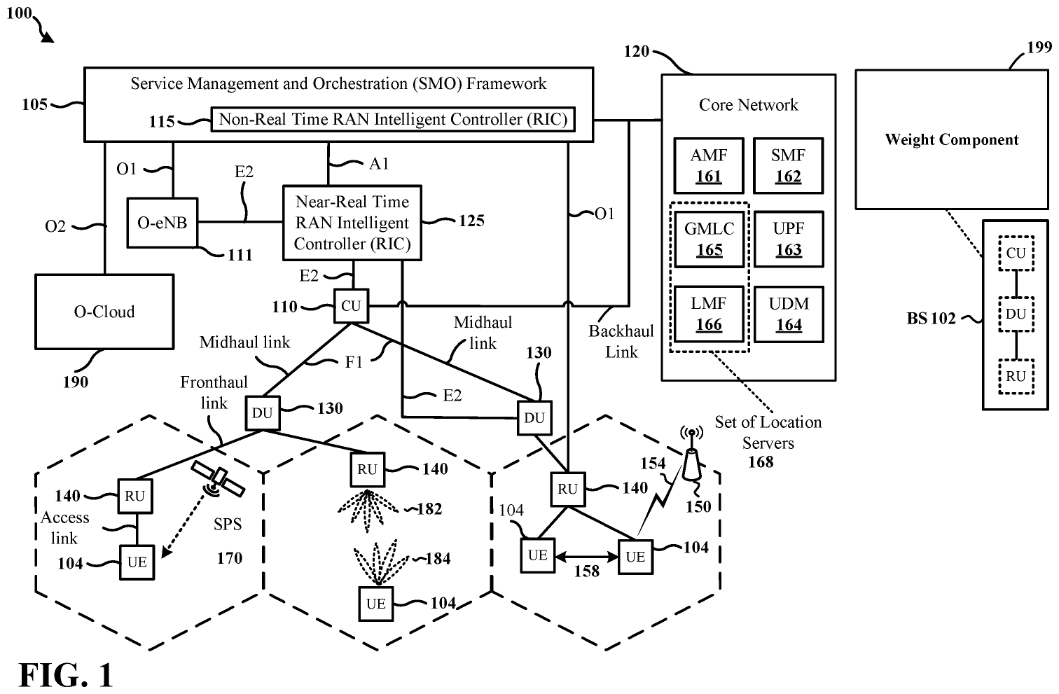

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

In certain aspects, the base station 102, the base station 102, such as the RU or the DU, may include a weight component 199. In some aspects, the weight component 199 may be at the DU and may be configured to transmit to a second network entity, a first indication of a diversity and a second indication of a first quantity of scheduled layers associated with the first network entity. In some aspects, the weight component 199 may be configured to transmit to the second network entity, a set of beamforming weights based on the indication of the diversity and the first quantity of scheduled layers. In some aspects, the weight component 199 may at the RU and may be configured to transmit, to a second network entity, a set of sounding reference signal (SRS) samples. In some aspects, the weight component 199 may be configured to receive, from the second network entity, a first indication of a diversity and a second indication of a first quantity of scheduled layers associated with the first network entity. In some aspects, the weight component 199 may be configured to receive, from the second network entity, a set of beamforming weights based on the indication of the diversity and the first quantity of scheduled layers, the set of beamforming weights being based on the set of SRS samples.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

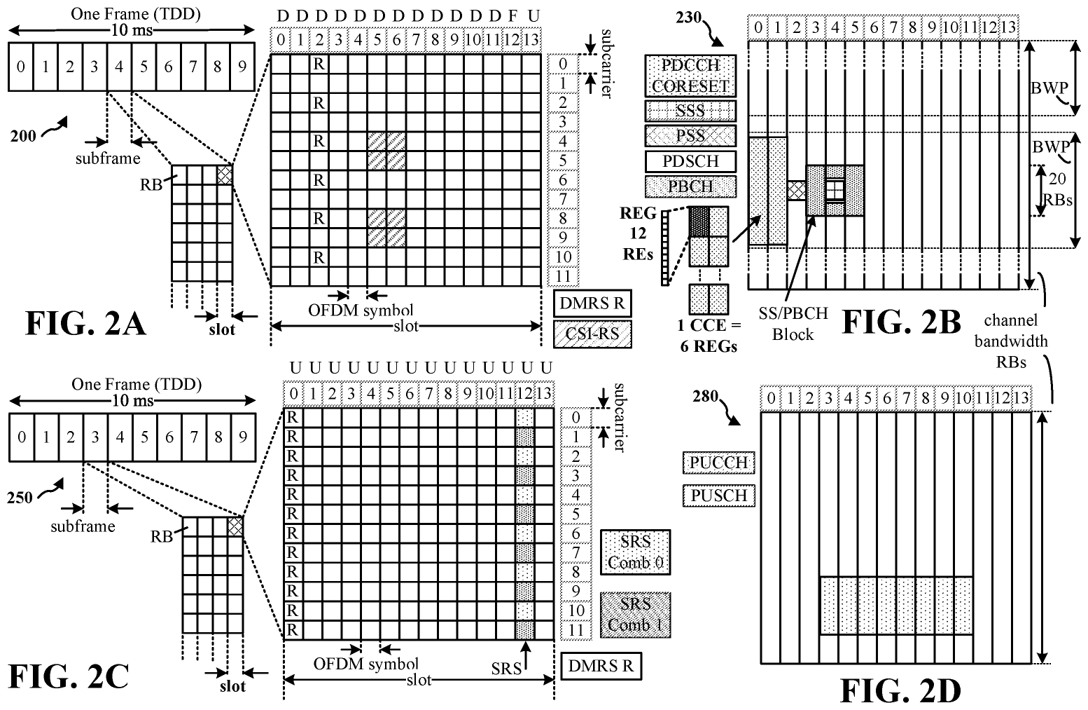

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| u | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

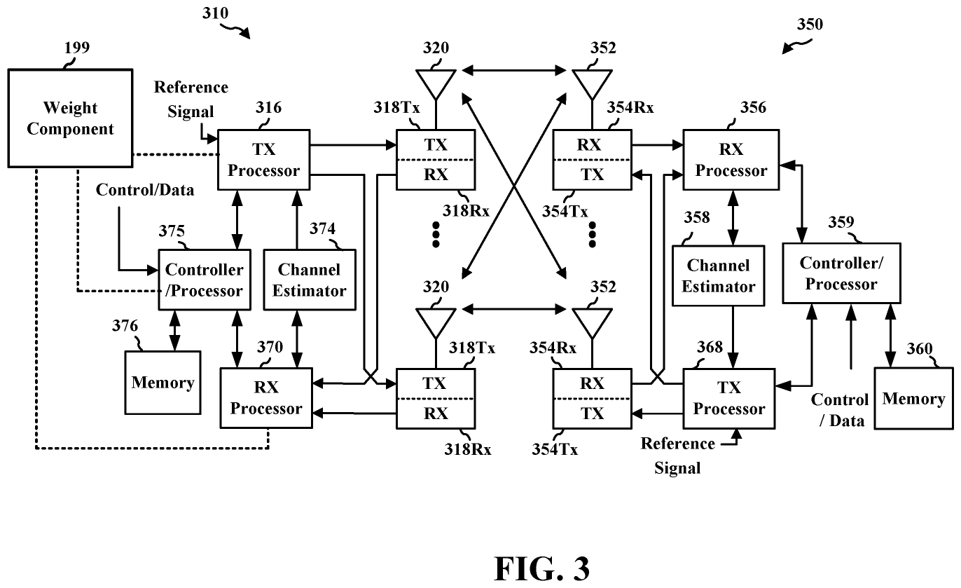

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with weight component 199 of FIG. 1.

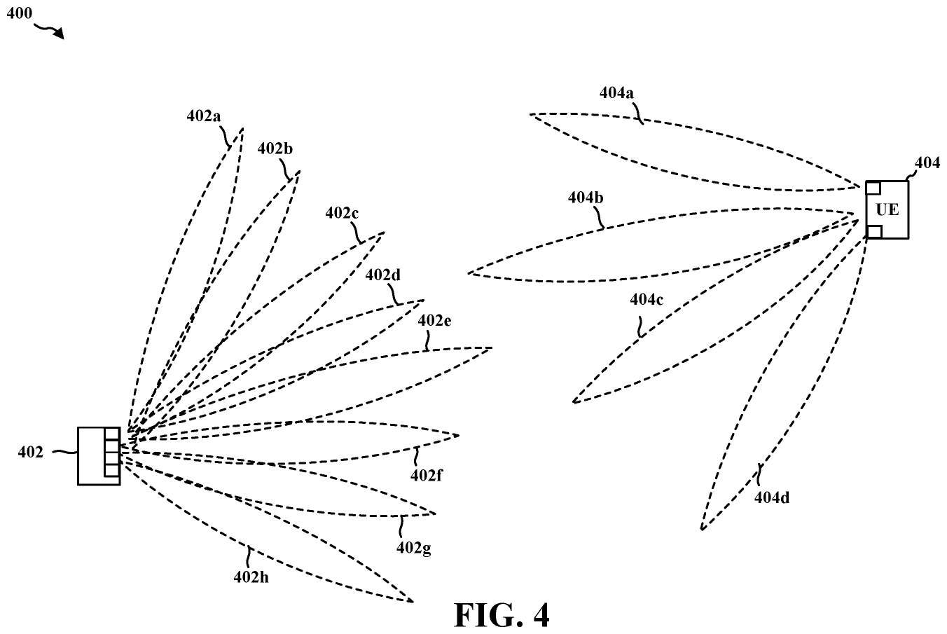

FIG. 4 is a diagram 400 illustrating a network node 402 in communication with a UE 404. Referring to FIG. 4, the network node 402 may transmit a beamformed signal to the UE 404 in one or more of the directions 402a, 402b, 402c, 402d, 402c, 402f, 402g, 402h. The UE 404 may receive the beamformed signal from the network node 402 in one or more receive directions 404a, 404b, 404c, 404d. The UE 404 may also transmit a beamformed signal to the network node 402 in one or more of the directions 404a-404d. The network node 402 may receive the beamformed signal from the UE 404 in one or more of the receive directions 402a-402h. The network node 402/UE 404 may perform beam training to determine the best receive and transmit directions for each of the network node 402/UE 404. The transmit and receive directions for the network node 402 may or may not be the same. The transmit and receive directions for the UE 404 may or may not be the same. The term beam may be otherwise referred to as “spatial filter.” Beamforming may be otherwise referred to as “spatial filtering.” As used herein, the term “beam” may correspond to “spatial filter.”

In response to different conditions, the UE 404 may determine to switch beams, e.g., between beams 402a-402h. The beam at the UE 404 may be used for reception of downlink communication and/or transmission of uplink communication. In some examples, the network node 402 may send a transmission that triggers a beam switch by the UE 404. A Transmission Configuration Indication (TCI) state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCH DM-RS ports. TCI states can provide information about different beam selections for the UE to use for transmitting/receiving various signals. For example, the network node 402 may indicate a TCI state change, and in response, the UE 404 may switch to a new beam (which may be otherwise referred to as performing a beam switch) according to the new TCI state indicated by the network node 402.

One type of beamforming may include codebook-based beam scanning. A codebook may include information corresponding to a beam used for communication, such as a beam index, direction, beam weights across antennas, antenna ordering information, beam steering information (e.g., angles in azimuth and/or zenith), and/or other information associated with a beam. For example, a codebook may include a collection of beamforming vectors (e.g., fixed or predefined beamforming vectors), as well as techniques for generating and/or combining vectors (both static as well as dynamic). Beamforming codebooks may be either designed for rank-1 analog beamforming or for higher rank precoding applications. An example of a codebook may include a matrix of beam weights with different column vectors corresponding to the weights used across different antennas for a certain layer of data transmission.

Another type of beamforming may be non-codebook based, which may be referred to as “dynamic beamforming.” For dynamic beamforming in uplink, SRS may be sent from UE to the RU, and the RU may transmit raw SRS samples to DU so that the DU may perform spatial processing on these samples and compute beamforming weights, which may also be referred to as “beam weights.”

A base station of the O-RAN may include an O-RAN distributed unit (O-DU) and an O-RAN radio unit (O-RU), lower layer function being split between the O-DU and O-RU based on a lower layer functional split. That is, the O-DU may refer to a logical node configured to host an RLC layer, a MAC layer, and High-PHY layers based on a lower layer functional split. The O-RU may refer to a logical node configured to host the Low-PHY layer and RF processing based on a lower layer functional split. The O-RAN may include an open fronthaul (FH) interface between the O-DU and the O-RU, and the open FH interface may include a control user synchronization (CUS) plane and a management (M) plane.

The C-plane is a control plane that may refer specifically to real-time control between the O-DU and the O-RU. The U-plane is a user plane that may refer to IQ sample data transferred between the O-DU and the O-RU. The S-plane is a synchronization plane that may refer to traffic between the O-RU or the O-DU to the synchronization controller. The M-plane is a management plane that may refer to management operations sharing the configuration management between the O-DU and the O-RU.

On boot-up of the network system, a set of configuration management messages may be exchanged on the M-plane between the O-DU and the O-RU. The O-DU and the O-RU may configure the M-plane accordingly and use the configuration for the CUS-plane communication.

After the network system boot-up, the M-plane configuration may be dynamically changed through remote procedure call (RPC) messages. For example, the O-DU and the O-RU may dynamically change the M-plane configuration with get-config and edit-config RPCs. In some aspects, the O-DU and the O-RU may exchange a protocol, using the RPC messages. The RPC messages may dynamically change the M-plane configuration between the O-DU and the O-RU.

As used herein, the term “TRX” may refer to a specific processing chain in an O-RU associated with digital to analog (D/A) or analog to digital (A/D) converters. By way of example, a processing chain may involve digital signal as an input, process the digital signal using a digital to analog converter, use a low pass filter to process an output of the digital to analog converter, perform frequency up-convert based on a local oscillator, amplify the signal using a power amplifier, filter the signal based on an band pass filter, and process the signal based on phase shifters. A TRX may correspond to a fronthaul stream.

As used herein, the term “fronthaul” may refer to a logical link connecting O-DU and O-RU.

As used herein, the term “spatial stream” may refer to a data flow on the DL associated with precoded data (may be same as layers or different if there is expansion in the precoding), and on UL associated with the number of outputs from the digital beamforming. Due to digital beamforming the number of TRXs may exceed the number of fronthaul streams and due to analog beamforming, the number of TRXs may be lower than the number of antenna elements. A “spatial stream” may correspond to a scheduled layer.

A particular type of signaling used for transmitting beamforming weights may be referred to as “section extension 11.” In some wireless communication systems, beamforming weights may be transmitted for all TRXs for each bundle present in the system. In scenarios of diversity variant (where the number of scheduled layers is less than the number of fronthaul streams) of uplink beamforming, non-zero beamforming weight(s) may be sent for some TRXs and for the rest of TRXs a beamforming weight of zero may be sent for both in-phase (I) and quadrature (Q) component. For example, for an eight TRX system having eight fronthaul streams, in some wireless communication systems, a C-plane message may be sent for a PUSCH for one UE having one layer spread across eight fronthaul streams and may indicate that the beamforming weight for TRX 3 has a non-zero value and the beamforming weight(s) for TRX 0-2 and TRXs 4-7 are all zero. Aspects provided herein may facilitate reducing the size of a C-plane message by introducing new parameters to the C-plane message carrying beam weight(s) and reduce the instances where a beamforming weight of zero would be transmitted. Based on aspects provided herein, a C-plane message carrying beam weight(s) may include a diversity parameter which may inform O-RU regarding whether O-RU diversity variant of uplink beamforming is enabled and a numLayers parameter which may indicate the number of scheduled layers.

Based on aspects provided herein, table 2 below provides example data format for section extension 11:

TABLE 2
example data format for sending beamforming weights

| ef = 1 | extType = 0x13 | | | | 1 | Octet N |
|---|---|---|---|---|---|---|
| extLen[15:0] | | | | | 2 | Octet N + 1 |
| disableBFWs | RAD | diversity | numLayers[4:2] | reserved | 1 | Octet N + 3 |

| numBundPrb[7:0] | | 1 | Octet N + 5 |
|---|---|---|---|
| bfwCompHdr[7:0] | | 1 | Octet N + 6 |
| bfwCompParam (for PRB bundle 0) | | var | |
| reserved | beamId[14:8] (for PRB bundle 0) | 1 | |
| | beamId[7:0] (for PRB bundle 0) | 1 | |
| bfwI (for TRX 0 and PRB bundle 0) | | var | |
| bfwCompParam (for PRB bundle 0) | | var | |
| remaining beamforming weights bfwI and bfwQ up to L TRXs and | | var | |
| PRB bundle 0 | | | |
| bfwCompParam (for PRB bundle 1) | | var | |
| reserved | beamId[14:8] (for PRB bundle 1) | 1 | |
| | beamId[7:0] (for PRB bundle 1) | 1 | |
| bfwI (for TRX 0 and PRB bundle 1) | | var | |
| bfwCompParam (for PRB bundle 1) | | var | |
| remaining beamforming weights bfwI and bfwQ up to L TRXs and | | var | |
| PRB bundle 1 | | | |
| bfwCompParam (for PRB last bundle) | | var | |
| reserved | beamId[14:8] (for last bundle) | 1 | |
| | beamId[7:0] (for last bundle) | 1 | |

| | |
|---|---|
| bfwI (for TRX 0 and last bundle) | var |
| bfwCompParam (for last bundle | var |
| remaining beamforming weights bfwI and bfwQ up to L TRXs and | var |
| last bundle | |

The parameter ef may represent extension flag and may be used to indicate if there is another extension present (ef=1) or this is the last extension (ef=0).

The parameter disable BFWs may represent disable beamforming weights and may be used to indicate whether beamforming weights under Section Extension are disabled or not.

The parameter RAD may represent reset after PRB discontinuity and may be used when the section extension is used in conjunction with another section extension allowing non-contiguous frequency allocation. When the section parameters refer to a continuous set of PRBs, the default value may be used, which may be RAD=1. When Section Extension allowing non-contiguous frequency allocation is used with Section Extension 11, this parameter indicates whether the PRB bundle boundary is reset after discontinuity in the PRB allocation (RAD=1), or the PRB bundle boundaries are mapped to the PRBs regardless of the discontinuity.

The parameter diversity may represent whether O-RU diversity variant (number of scheduled layers is less than number of fronthaul streams) of uplink beamforming is enabled. The parameter diversity may be a binary flag that may be set to “true” or “false.” When the parameter diversity is set to true which may represent that O-RU diversity variant of uplink beamforming is enabled, beam-weights may be sent for applicable number of TRXs but not sent for all TRXs in system. For example, the applicable TRXs may correspond to the TRXs that are associated with a fronthaul stream. An O-RU may assume that beamforming weights for other TRXs are zero.

The parameter numLayers may aid an O-RU to compute the number of TRXs for which beamforming weights would be set as zero. In some aspects, the parameter numLayers may represent the total number of scheduled layers. In some aspects, the parameter numLayers may represent the total number of scheduled layers which beamforming weights would be set as zero. In some aspects, the parameter numLayers may be used to indicate the number of layers present in system, helps O-RU in computing number of TRXs for which beamforming weights would be set as 0. In some aspects, the parameter numLayers may have a defined value range:

TABLE 3
example value range

| numLayers | Number of layers |
|---|---|
| 000b | Reserved |
| 001b | 1 |
| 010b | 2 |
| 011b | 4 |
| 100b | 8 |
| 101b | 16 |
| 110b | 32 |
| 111b | 64 |

The parameter extType may represent extension type and may provide the extension type which provides additional parameters specific to the subject data extension.

The parameter extLen may represent extension length and may provide the length of the data format in units of 32-bit (or 4-byte) words.

The parameter numBundPrb may represent number of bundled PRBs per beamforming weights and may be the number of bundled PRBs per beamforming weight sets.

The parameter bfwCompHdr may represent beamforming weight compression header and may define the compression method and IQ bit width for the beamforming weights in the C-plane message. For the block compression methods, the block size is the vector of beamforming weights for a specific PRB bundle.

The parameter bfwCompParam for PRB bundle x may represent beamforming weight compression parameter and may apply to a following vector of beamforming weights for a specific PRB bundle (bundle x).

The parameter beamId may represent beam identifier.

The parameters bfwI and bfwQ may represent beamforming weights I and Q values, where bfwI may represent time-domain beamforming weight in-phase value and bfwQ may represent time-domain beamforming weight quadrature-phase value.

In some aspects, beamforming weights for k-th fronthaul stream (FHS) may be in the structure of [precedingTRXsWeights applicableTRXWeights trailingTRXWeights], where the parameter precedingTRXs Weights represents the beamforming weights for TRXs preceding the applicable TRX, the parameter applicableTRXWeights may represent the beamforming weights for applicable TRX which corresponds to a scheduled layer, and trailingTRXWeights represents the beamforming weights for TRXs after the applicable TRX. The applicable TRX beam-weights may be sent in a C-plane message and beamforming weights for precedingTRXs and trailingTRXweights may be zero A O-RU may compute the quantity of TRXs preceding the applicable TRX and the quantity of TRXs after the applicable TRX based on:

```
diversityFactor = numFHS/numLayers
for (j=0, i = 0; i < numFHS; i++, j++)
{
  if (j == diversityFactor)
    j=0
  numPrecedingTRX = j * numApplicableTRX
  numTrailingTRX = numTRX − numApplicableTRX −
numPrecedingTRX
}
```

The parameter numFHS may represent the quantity of fronthaul streams. The parameter numLayers may represent the quantity of scheduled layers. The parameter numTRX may represent the total quantity of TRX.

The parameter numApplicableTRX may be directly computed by C-plane and may represent the number of TRXs for which beamforming weights may be sent. The parameter numFHS may be equal to number of eaxcids (extended antenna-carrier identifier) for one allocation.

In some aspects, an M-plane capability may be introduced to indicate whether O-RU supports diversity or setting beamforming weights of TRX(s) that do not correspond with fronthaul stream(s) to zero, which may be in the form of: +—ro cplane-diversity-indicator-supported Boolean. For example, in some aspects, the O-RU 502 may transmit, for the O-DU 504, a capability indication 505 (e.g., in the form of “cplane-diversity-indicator-supported”) indicating whether the O-RU 502 supports diversity or setting beamforming weights of TRX(s) that do not correspond with fronthaul stream(s) to zero.

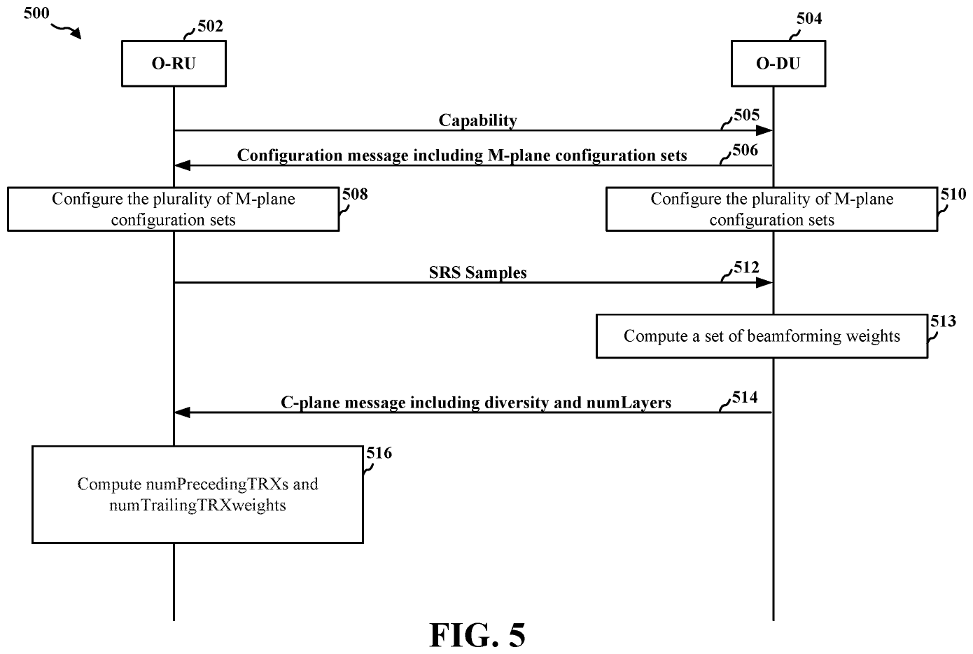

FIG. 5 is a diagram 500 illustrating example communications between a first network entity, which may be a O-RU 502, and a second network entity, which may be a O-DU 504.

At 506, the O-DU 504 may transmit, to the O-RU 502, a configuration message including a plurality of M-plane configuration sets, each M-plane configuration set comprising a set of M-plane configuration parameters. That is, the O-DU 504 may notify the plurality of M-plane configuration sets to the O-RU 502. For example, the O-DU 504 may transmit, to the O-RU 502, at least one RPC message including one or more parameters pairs of the M-plane configuration ID and an activation period.

At 508, the O-RU 502 may configure a plurality of M-plane configuration sets based on the configuration message received at 506. At 510, the O-DU 504 may configure the plurality of M-plane configuration sets based on the configuration message transmitted at 506.

At 512, the O-RU 502 may transmit, to the O-DU 504, SRS samples, which may be raw SRS samples. After receiving the SRS samples at 512, at 513, the O-DU 504 may compute a set of beamforming weights associated with applicable TRX(s) (one or more TRX that correspond to one or more scheduled layers).

At 514, the O-DU 504 may transmit, to the O-RU 502, a C-plane message as described in connection with table 2, which may include a first indication of a diversity (e.g., the parameter diversity) and a second indication of a quantity of scheduled layers (e.g., the parameter numLayers), along with a set of beamforming weights associated with applicable TRX(s) (one or more TRX that correspond to one or more scheduled layers). The C-plane message may not include beamforming weights of value zero for I or Q component for the non-applicable TRX(s) (one or more TRX that do not correspond to one or more scheduled layers).

After receiving the C-plane message at 514, at 516, the O-RU 502 may compute the quantity of TRXs preceding the applicable TRX and the quantity of TRXs after the applicable TRX based on:

```
diversityFactor = numFHS/numLayers
for (j=0, i = 0; i < numFHS; i++, j++)
{
  if (j == diversityFactor)
    j=0
  numPrecedingTRX = j * numApplicableTRX
  numTrailingTRX = numTRX − numApplicableTRX −
numPrecedingTRX
}
```

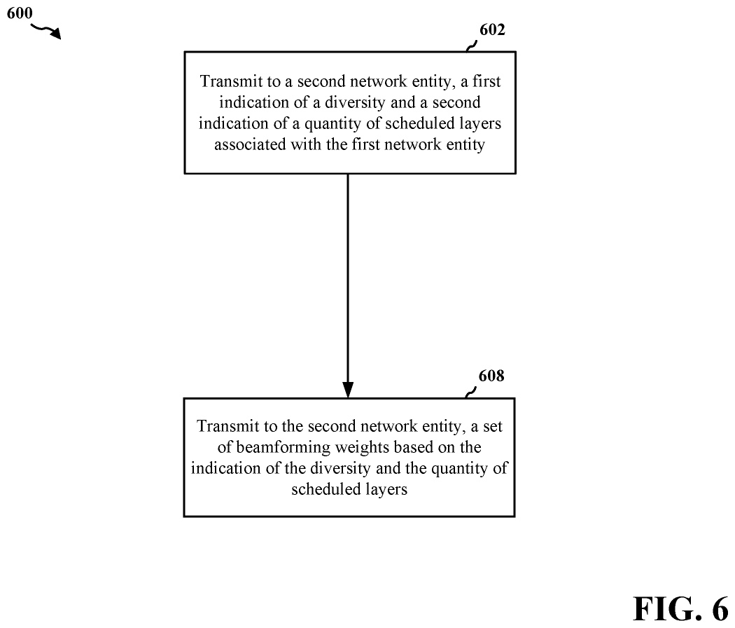

FIG. 6 is a flowchart 600 of a method of wireless communication. The method may be performed by a network entity (e.g., the base station 102, the network entity 902, the network entity 1060). Aspects provided herein reduce the size of a C-plane message by introducing new parameters to the C-plane message carrying beam weight(s) and reduce the instances where a beamforming weight of zero would be transmitted.

At 602, the network entity may transmit to a second network entity, a first indication of a diversity and a second indication of a quantity of scheduled layers associated with the first network entity. For example, the network entity (e.g., O-DU 504) may transmit to a second network entity (e.g., O-RU 502), a first indication of a diversity and a second indication of a quantity of scheduled layers associated with the first network entity (e.g., at 514). In some aspects, 602 may be performed by weight component 199.

At 608, the network entity may transmit to the second network entity, a set of beamforming weights based on the indication of the diversity and the quantity of scheduled layers. For example, the network entity may transmit to the second network entity, a set of beamforming weights based on the indication of the diversity and the quantity of scheduled layers (e.g., at 514). In some aspects, 606 may be performed by weight component 199.

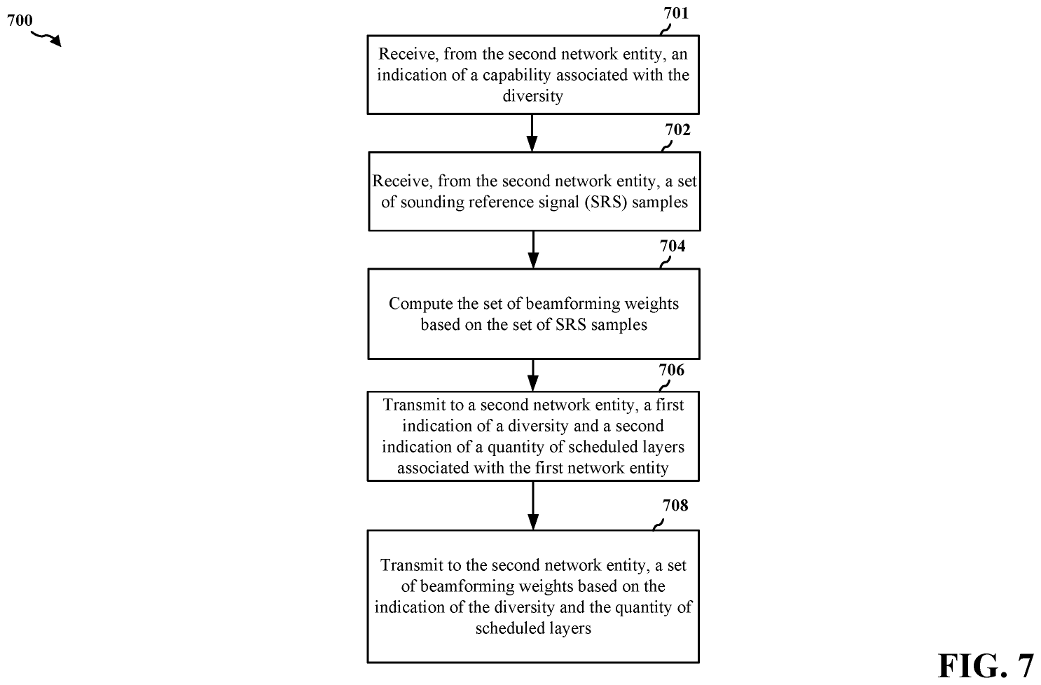

FIG. 7 is a flowchart 700 of a method of wireless communication. The method may be performed by a network entity (e.g., the base station 102, the network entity 902, the network entity 1060). Aspects provided herein reduce the size of a C-plane message by introducing new parameters to the C-plane message carrying beam weight(s) and reduce the instances where a beamforming weight of zero would be transmitted.

At 701, the network entity may receive, from the second network entity, an indication of a capability associated with the diversity. For example, the network entity may receive, from the second network entity, an indication of a capability (e.g., 505) associated with the diversity. At 702, the network entity may receive, from the second network entity, a set of SRS samples. For example, the network entity may receive, from the second network entity, a set of SRS samples (e.g., at 512). In some aspects, 701 and 702 may be performed by weight component 199.

At 704, the network entity may compute the set of beamforming weights based on the set of SRS samples. For example, the network entity may compute the set of beamforming weights based on the set of SRS samples (e.g., at 513). In some aspects, 704 may be performed by weight component 199.

At 706, the network entity may transmit to a second network entity, a first indication of a diversity and a second indication of a quantity of scheduled layers associated with the first network entity. For example, the network entity (e.g., O-DU 504) may transmit to a second network entity (e.g., O-RU 502), a first indication of a diversity and a second indication of a quantity of scheduled layers associated with the first network entity (e.g., at 514). In some aspects, 706 may be performed by weight component 199.

At 708, the network entity may transmit to the second network entity, a set of beamforming weights based on the indication of the diversity and the quantity of scheduled layers. For example, the network entity may transmit to the second network entity, a set of beamforming weights based on the indication of the diversity and the quantity of scheduled layers (e.g., at 514). In some aspects, 706 may be performed by weight component 199.

In some aspects, the first indication of the diversity indicates whether the quantity of scheduled layers is smaller than a quantity of fronthaul streams (e.g., a first quantity of scheduled layers is smaller than a second quantity of fronthaul streams). In some aspects, the first indication of the diversity indicates whether a diversity variant is enabled to allow the quantity of scheduled layers to be smaller than a quantity of fronthaul streams. In some aspects, the first indication is a binary flag indicating whether the diversity variant is enabled or disabled. In some aspects, the second indication indicates the quantity of scheduled layers based on indicating a particular value from a set of configured values. In some aspects, the set of beamforming weights includes a quantity of beamforming weights, and where a quantity of transceivers associated with the second network entity and associated with the quantity of beamforming weights is based on the diversity and equal to a total number of front haul streams divided by the quantity of scheduled layers. In some aspects, a second set of beamforming weights associated with a set of remaining transceivers different from the quantity of transceivers are equal to zero. For example, the quantity of transceivers may be computed by the second network entity as total number of front haul streams divided by the number of layers, and the beamforming weights for remaining transceivers may be assumed as zero by the second network entity. The quantity of beamforming weights may be referred to as a second quantity of beamforming weights, and the quantity of transceivers may be referred to as a third quantity of transceivers, in some aspects.

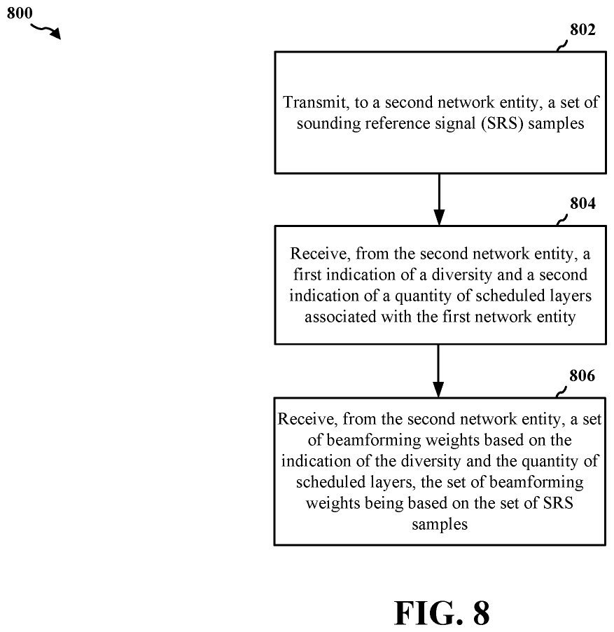

FIG. 8 is a flowchart 800 of a method of wireless communication. The method may be performed by a network entity (e.g., the base station 102, the network entity 902, the network entity 1060). Aspects provided herein reduce the size of a C-plane message by introducing new parameters to the C-plane message carrying beam weight(s) and reduce the instances where a beamforming weight of zero would be transmitted.

At 802, the network entity may transmit, to a second network entity, a set of SRS samples. For example, the network entity (e.g., O-RU 502) may transmit, to a second network entity (e.g., O-DU 504), a set of SRS samples (e.g., 512). In some aspects, 802 may be performed by weight component 199.

At 804, the network entity may receive, from the second network entity, a first indication of a diversity and a second indication of a quantity of scheduled layers associated with the first network entity. For example, the network entity (e.g., O-RU 502) may receive, from the second network entity (e.g., at 514), a first indication of a diversity and a second indication of a quantity of scheduled layers associated with the first network entity. In some aspects, 804 may be performed by weight component 199.

At 806, the network entity may receive, from the second network entity (e.g., at 514), a set of beamforming weights based on the indication of the diversity and the quantity of scheduled layers, the set of beamforming weights being based on the set of SRS samples. For example, the network entity (e.g., O-RU 502) may receive, from the second network entity, a set of beamforming weights based on the indication of the diversity and the quantity of scheduled layers, the set of beamforming weights being based on the set of SRS samples. In some aspects, 806 may be performed by weight component 199. In some aspects, the first indication of the diversity indicates whether the quantity of scheduled layers is smaller than a quantity of fronthaul streams (e.g., a first quantity of scheduled layers is smaller than a second quantity of fronthaul streams). In some aspects, the first indication of the diversity indicates whether a diversity variant is enabled to allow the quantity of scheduled layers to be smaller than a quantity of fronthaul streams. In some aspects, the first indication is a binary flag indicating whether the diversity variant is enabled or disabled. In some aspects, the second indication indicates the quantity of scheduled layers based on indicating a particular value from a set of configured values. In some aspects, the set of beamforming weights includes a quantity of beamforming weights, and where a quantity of transceivers associated with the second network entity and associated with the quantity of beamforming weights is based on the diversity and equal to a total number of front haul streams divided by the quantity of scheduled layers. The quantity of beamforming weights may be referred to as a second quantity of beamforming weights, and the quantity of transceivers may be referred to as a third quantity of transceivers, in some aspects. In some aspects, a second set of beamforming weights associated with a set of remaining transceivers different from the quantity of transceivers are equal to zero.

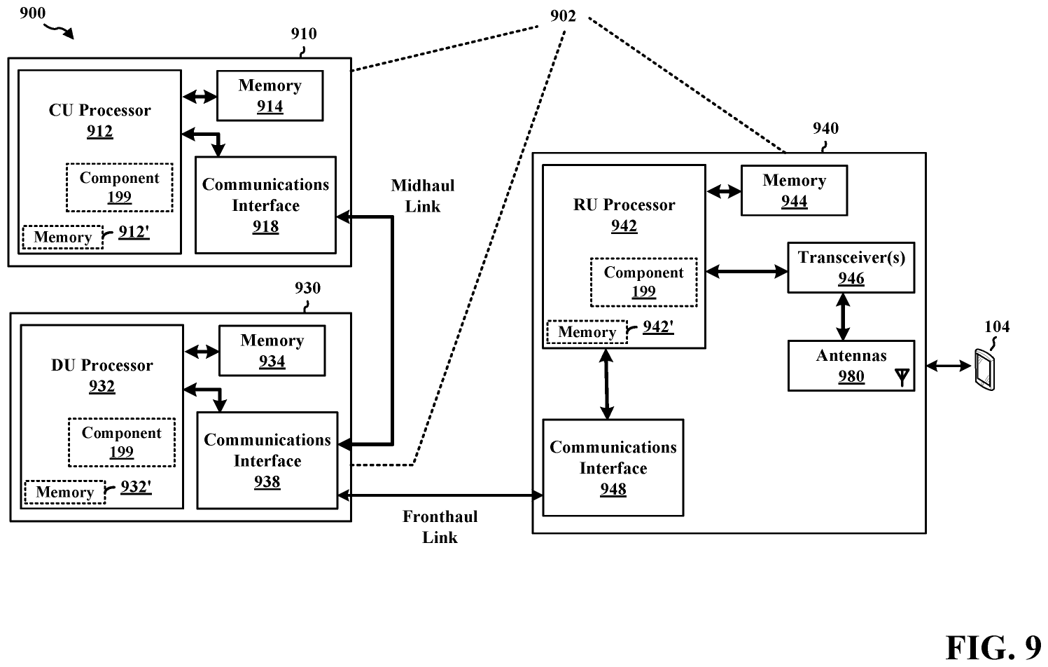

FIG. 9 is a diagram 900 illustrating an example of a hardware implementation for a network entity 902. The network entity 902 may be a BS, a component of a BS, or may implement BS functionality. The network entity 902 may include at least one of a CU 910, a DU 930, or an RU 940. For example, depending on the layer functionality handled by the component 199, the network entity 902 may include the CU 910; both the CU 910 and the DU 930; each of the CU 910, the DU 930, and the RU 940; the DU 930; both the DU 930 and the RU 940; or the RU 940. The CU 910 may include at least one CU processor 912. The CU processor(s) 912 may include on-chip memory 912′. In some aspects, the CU 910 may further include additional memory modules 914 and a communications interface 918. The CU 910 communicates with the DU 930 through a midhaul link, such as an F1 interface. The DU 930 may include at least one DU processor 932. The DU processor(s) 932 may include on-chip memory 932′. In some aspects, the DU 930 may further include additional memory modules 934 and a communications interface 938. The DU 930 communicates with the RU 940 through a fronthaul link. The RU 940 may include at least one RU processor 942. The RU processor(s) 942 may include on-chip memory 942′. In some aspects, the RU 940 may further include additional memory modules 944, one or more transceivers 946, antennas 980, and a communications interface 948. The RU 940 communicates with the UE 104. The on-chip memory 912′, 932′, 942′ and the additional memory modules 914, 934, 944 may each be considered a computer-readable medium/memory. Each computer-readable medium/memory may be non-transitory. Each of the processors 912, 932, 942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the weight component 199 may be at the DU and may be configured to transmit to a second network entity, a first indication of a diversity and a second indication of a quantity of scheduled layers associated with the first network entity. In some aspects, the weight component 199 may be configured to transmit to the second network entity, a set of beamforming weights based on the indication of the diversity and the quantity of scheduled layers. In some aspects, the weight component 199 may at the RU and may be configured to transmit, to a second network entity, a set of sounding reference signal (SRS) samples. In some aspects, the weight component 199 may be configured to receive, from the second network entity, a first indication of a diversity and a second indication of a quantity of scheduled layers associated with the first network entity. In some aspects, the weight component 199 may be configured to receive, from the second network entity, a set of beamforming weights based on the indication of the diversity and the quantity of scheduled layers, the set of beamforming weights being based on the set of SRS samples. The weight component 199 may be within one or more processors of one or more of the CU 910, DU 930, and the RU 940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 902 may include a variety of components configured for various functions. In one configuration, the network entity 902 may include means for transmitting, to a second network entity, a first indication of a diversity and a second indication of a quantity of scheduled layers associated with the first network entity. In some aspects, the network entity 902 may include means for transmitting, to the second network entity, a set of beamforming weights based on the indication of the diversity and the quantity of scheduled layers. In some aspects, the network entity 902 may include means for receiving, from the second network entity, a set of sounding reference signal (SRS) samples. In some aspects, the network entity 902 may include means for computing the set of beamforming weights based on the set of SRS samples. In some aspects, the network entity 902 may include means for transmitting, to a second network entity, a set of sounding reference signal (SRS) samples. In some aspects, the network entity 902 may include means for receiving, from the second network entity, a first indication of a diversity and a second indication of a quantity of scheduled layers associated with the first network entity. In some aspects, the network entity 902 may include means for receiving, from the second network entity, a set of beamforming weights based on the indication of the diversity and the quantity of scheduled layers, the set of beamforming weights being based on the set of SRS samples. The means may be the component 199 of the network entity 902 configured to perform the functions recited by the means. As described supra, the network entity 902 may include the TX processor 316, the RX processor 370, and the controller/processor 375. As such, in one configuration, the means may be the TX processor 316, the RX processor 370, and/or the controller/processor 375 configured to perform the functions recited by the means.

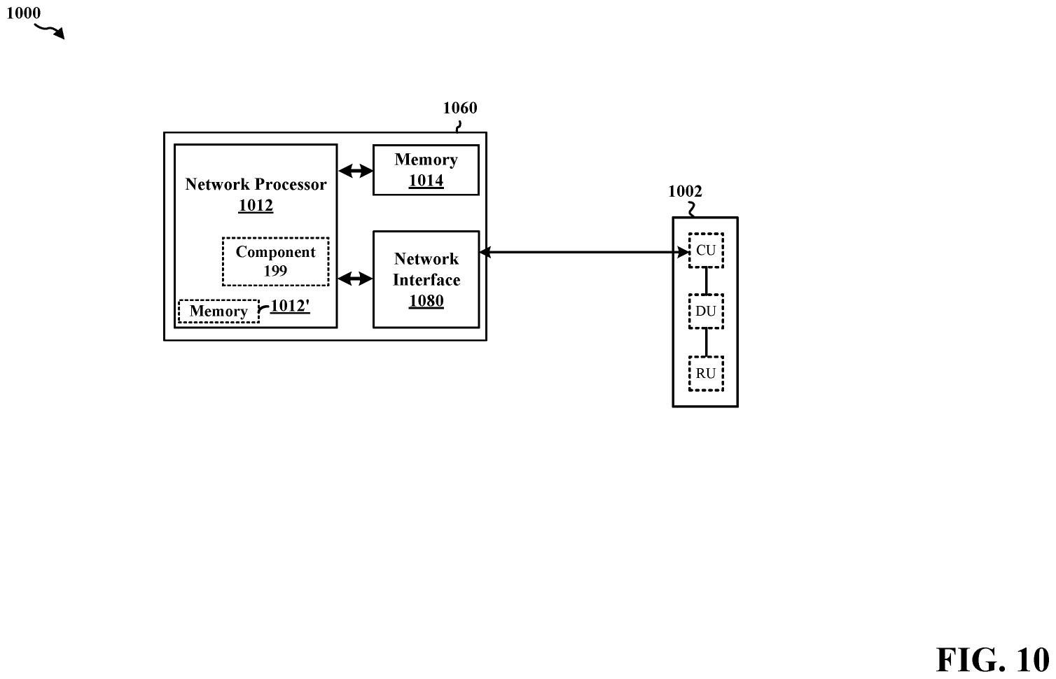

FIG. 10 is a diagram 1000 illustrating an example of a hardware implementation for a network entity 1060. In one example, the network entity 1060 may be within the core network 120. The network entity 1060 may include at least one network processor 1012. The network processor(s) 1012 may include on-chip memory 1012′. In some aspects, the network entity 1060 may further include additional memory modules 1014. The network entity 1060 communicates via the network interface 1080 directly (e.g., backhaul link) or indirectly (e.g., through a RIC) with the CU 1002. The on-chip memory 1012′ and the additional memory modules 1014 may each be considered a computer-readable medium/memory. Each computer-readable medium/memory may be non-transitory. The network processor(s) 1012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the weight component 199 may be at the DU and may be configured to transmit to a second network entity, a first indication of a diversity and a second indication of a quantity of scheduled layers associated with the first network entity. In some aspects, the weight component 199 may be configured to transmit to the second network entity, a set of beamforming weights based on the indication of the diversity and the quantity of scheduled layers. In some aspects, the weight component 199 may at the RU and may be configured to transmit, to a second network entity, a set of sounding reference signal (SRS) samples. In some aspects, the weight component 199 may be configured to receive, from the second network entity, a first indication of a diversity and a second indication of a quantity of scheduled layers associated with the first network entity. In some aspects, the weight component 199 may be configured to receive, from the second network entity, a set of beamforming weights based on the indication of the diversity and the quantity of scheduled layers, the set of beamforming weights being based on the set of SRS samples. The component 199 may be within the network processor(s) 1012. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1060 may include a variety of components configured for various functions. In one configuration, the network entity 1060 may include means for transmitting, to a second network entity, a first indication of a diversity and a second indication of a quantity of scheduled layers associated with the first network entity. In some aspects, the network entity 1060 may include means for transmitting, to the second network entity, a set of beamforming weights based on the indication of the diversity and the quantity of scheduled layers. In some aspects, the network entity 1060 may include means for receiving, from the second network entity, a set of sounding reference signal (SRS) samples. In some aspects, the network entity 1060 may include means for computing the set of beamforming weights based on the set of SRS samples. In some aspects, the network entity 1060 may include means for transmitting, to a second network entity, a set of sounding reference signal (SRS) samples. In some aspects, the network entity 1060 may include means for receiving, from the second network entity, a first indication of a diversity and a second indication of a quantity of scheduled layers associated with the first network entity. In some aspects, the network entity 1060 may include means for receiving, from the second network entity, a set of beamforming weights based on the indication of the diversity and the quantity of scheduled layers, the set of beamforming weights being based on the set of SRS samples. The means may be the component 199 of the network entity 1060 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method for wireless communication performed by a first network entity, including: transmitting, to a second network entity, a first indication of a diversity and a second indication of a first quantity of scheduled layers associated with the first network entity; and transmitting, to the second network entity, a set of beamforming weights based on the indication of the diversity and the first quantity of scheduled layers.
Aspect 2 is the method of aspect 1, where the first indication of the diversity indicates whether the first quantity of scheduled layers is smaller than a second quantity of fronthaul streams.
Aspect 3 is the method of any of aspects 1-2, where the first indication of the diversity indicates whether a diversity variant is enabled to allow the first quantity of scheduled layers to be smaller than a second quantity of fronthaul streams.
Aspect 4 is the method of aspect 3, where the first indication is a binary flag indicating whether the diversity variant is enabled or disabled.
Aspect 5 is the method of any of aspects 1-4, where the second indication indicates the first quantity of scheduled layers based on indicating a particular value from a set of configured values.
Aspect 6 is the method of any of aspects 1-5, where the set of beamforming weights includes a second quantity of beamforming weights, and where a third quantity of transceivers associated with the second network entity and associated with the quantity of beamforming weights is based on the diversity and equal to a total number of front haul streams divided by the first quantity of scheduled layers.
Aspect 7 is the method of aspect 6, where a second set of beamforming weights corresponding to one or more fronthaul streams are equal to zero, where the second set of beamforming weights is different from the set of beamforming weights.
Aspect 8 is the method of any of aspects 1-7, further including: receiving, from the second network entity, a third indication of a capability associated with the diversity; receiving, from the second network entity, a set of sounding reference signal (SRS) samples; and computing the set of beamforming weights based on the set of SRS samples.
Aspect 9 is a method for wireless communication performed by a first network entity, including: transmitting, to a second network entity, a set of sounding reference signal (SRS) samples; receiving, from the second network entity, a first indication of a diversity and a second indication of a first quantity of scheduled layers associated with the first network entity; and receiving, from the second network entity, a set of beamforming weights based on the indication of the diversity and the first quantity of scheduled layers, the set of beamforming weights being based on the set of SRS samples.
Aspect 10 is the method of aspect 9, where the first indication of the diversity indicates whether the first quantity of scheduled layers is smaller than a second quantity of fronthaul streams.
Aspect 11 is the method of any of aspects 9-10, where the first indication of the diversity indicates whether a diversity variant is enabled to allow the first quantity of scheduled layers to be smaller than a second quantity of fronthaul streams.
Aspect 12 is the method of aspect 11, where the first indication is a binary flag indicating whether the diversity variant is enabled or disabled.
Aspect 13 is the method of any of aspects 9-12, where the second indication indicates the first quantity of scheduled layers based on indicating a particular value from a set of configured values.
Aspect 14 is the method of any of aspects 9-13, where the set of beamforming weights includes a second quantity of beamforming weights, and where a third quantity of transceivers associated with the second network entity and associated with the quantity of beamforming weights is based on the diversity and equal to a total number of front haul streams divided by the first quantity of scheduled layers.
Aspect 15 is the method of any of aspects 9-14, where a second set of beamforming weights associated with a set of remaining transceivers different from the third quantity of transceivers are equal to zero.
Aspect 16 is an apparatus for wireless communication including at least one processor coupled to at least one memory and, based at least in part on information stored in the at least one memory, the at least one processor is configured to implement a method as in any of aspects 1 to 15.
Aspect 17 may be combined with aspect 16 and further includes a transceiver coupled to the at least one processor.
Aspect 18 is an apparatus for wireless communication including means for implementing any of aspects 1 to 15.
Aspect 19 is a non-transitory computer-readable storage medium storing computer executable code, where the code when executed by a processor causes the processor to implement any of aspects 1 to 15.

Various aspects have been described herein. These and other aspects are within the scope of the following claims.

What is claimed is:

1. An apparatus for wireless communication at a first network entity, comprising:
at least one memory; and
at least one processor coupled to the at least one memory and, based at least in part on stored information that is stored in the at least one memory, the at least one processor, individually or in any combination, is configured to cause the first network entity to:
transmit to a second network entity, a first indication of a diversity and a second indication of a first quantity of scheduled layers associated with the first network entity; and
transmit to the second network entity, a set of beamforming weights based on the first indication of the diversity and the first quantity of scheduled layers.

2. The apparatus of claim 1, wherein the first indication of the diversity indicates whether the first quantity of scheduled layers is smaller than a second quantity of fronthaul streams.

3. The apparatus of claim 1, wherein the first indication of the diversity indicates whether a diversity variant is enabled to allow the first quantity of scheduled layers to be smaller than a second quantity of fronthaul streams.

4. The apparatus of claim 3, wherein the first indication is a binary flag indicating whether the diversity variant is enabled or disabled.

5. The apparatus of claim 1, wherein the second indication indicates the first quantity of scheduled layers based on indicating a particular value from a set of configured values.

6. The apparatus of claim 1, wherein the set of beamforming weights comprises a second quantity of beamforming weights, and wherein a third quantity of transceivers associated with the second network entity and associated with the second quantity of beamforming weights is based on the diversity and equal to a total number of front haul streams divided by the first quantity of scheduled layers.

7. The apparatus of claim 6, wherein a second set of beamforming weights associated with a set of remaining transceivers different from the third quantity of transceivers are equal to zero.

8. The apparatus of claim 1, wherein the at least one processor, individually or in any combination, is further configured to cause the first network entity to:
receive, from the second network entity, a third indication of a capability associated with the diversity;
receive, from the second network entity, a set of sounding reference signal (SRS) samples; and
compute the set of beamforming weights based on the set of SRS samples.

9. An apparatus for wireless communication at a first network entity, comprising:
at least one memory; and
at least one processor coupled to the at least one memory and, based at least in part on stored information that is stored in the at least one memory, the at least one processor, individually or in any combination, is configured to cause the first network entity to:
transmit, to a second network entity, a set of sounding reference signal (SRS) samples;
receive, from the second network entity, a first indication of a diversity and a second indication of a first quantity of scheduled layers associated with the first network entity; and
receive, from the second network entity, a set of beamforming weights based on the first indication of the diversity and the first quantity of scheduled layers, the set of beamforming weights being based on the set of SRS samples.

10. The apparatus of claim 9, wherein the first indication of the diversity indicates whether the first quantity of scheduled layers is smaller than a second quantity of fronthaul streams.

11. The apparatus of claim 9, wherein the first indication of the diversity indicates whether a diversity variant is enabled to allow the first quantity of scheduled layers to be smaller than a second quantity of fronthaul streams.

12. The apparatus of claim 11, wherein the first indication is a binary flag indicating whether the diversity variant is enabled or disabled.

13. The apparatus of claim 9, wherein the second indication indicates the first quantity of scheduled layers based on indicating a particular value from a set of configured values.

14. The apparatus of claim 9, wherein the set of beamforming weights comprises a second quantity of beamforming weights, and wherein a third quantity of transceivers associated with the second network entity and associated with the second quantity of beamforming weights is based on the diversity and equal to a total number of front haul streams divided by the first quantity of scheduled layers.

15. The apparatus of claim 14, wherein a second set of beamforming weights associated with a set of remaining transceivers different from the third quantity of transceivers are equal to zero.

16. A method for wireless communication performed by a first network entity, comprising:
transmitting, to a second network entity, a first indication of a diversity and a second indication of a first quantity of scheduled layers associated with the first network entity; and
transmitting, to the second network entity, a set of beamforming weights based on the first indication of the diversity and the first quantity of scheduled layers.

17. The method of claim 16, wherein the first indication of the diversity indicates whether the first quantity of scheduled layers is smaller than a second quantity of fronthaul streams.

18. The method of claim 16, wherein the first indication of the diversity indicates whether a diversity variant is enabled to allow the first quantity of scheduled layers to be smaller than a second quantity of fronthaul streams.

19. The method of claim 18, wherein the first indication is a binary flag indicating whether the diversity variant is enabled or disabled.

20. The method of claim 16, wherein the second indication indicates the first quantity of scheduled layers based on indicating a particular value from a set of configured values.

21. The method of claim 16, wherein the set of beamforming weights comprises a second quantity of beamforming weights, and wherein a third quantity of transceivers associated with the second network entity and associated with the second quantity of beamforming weights is based on the diversity and equal to a total number of front haul streams divided by the first quantity of scheduled layers.

22. The method of claim 21, wherein a second set of beamforming weights corresponding to one or more fronthaul streams are equal to zero, wherein the second set of beamforming weights is different from the set of beamforming weights.

23. The method of claim 16, further comprising:
receiving, from the second network entity, a third indication of a capability associated with the diversity;
receiving, from the second network entity, a set of sounding reference signal (SRS) samples; and
computing the set of beamforming weights based on the set of SRS samples.

24. A method for wireless communication performed by a first network entity, comprising:
transmitting, to a second network entity, a set of sounding reference signal (SRS) samples;
receiving, from the second network entity, a first indication of a diversity and a second indication of a first quantity of scheduled layers associated with the first network entity; and
receiving, from the second network entity, a set of beamforming weights based on the first indication of the diversity and the first quantity of scheduled layers, the set of beamforming weights being based on the set of SRS samples.

25. The method of claim 24, wherein the first indication of the diversity indicates whether the first quantity of scheduled layers is smaller than a second quantity of fronthaul streams.

26. The method of claim 24, wherein the first indication of the diversity indicates whether a diversity variant is enabled to allow the first quantity of scheduled layers to be smaller than a second quantity of fronthaul streams.

27. The method of claim 26, wherein the first indication is a binary flag indicating whether the diversity variant is enabled or disabled.

28. The method of claim 24, wherein the second indication indicates the first quantity of scheduled layers based on indicating a particular value from a set of configured values.

29. The method of claim 24, wherein the set of beamforming weights comprises a second quantity of beamforming weights, and wherein a third quantity of transceivers associated with the second network entity and associated with the second quantity of beamforming weights is based on the diversity and equal to a total number of front haul streams divided by the first quantity of scheduled layers.

30. The method of claim 29, wherein a second set of beamforming weights associated with a set of remaining transceivers different from the third quantity of transceivers are equal to zero.
